(19) United States
(12) Patent Application Publication
(10) Pub. No.: US 2015/0304854 A1
(43) Pub. Date: Oct. 22, 2015

(54) METHOD OF SPECTRUM DETECTION AND DESIGN OF DETECTION FRAME STRUCTURE IN COMMUNICATION SYSTEM

(71) Applicant: ALCATEL LUCENT, Paris (FR)

(72) Inventors: Binyang Xu, Shanghai (CN); Jun Zhang, Shanghai (CN); Gaoning He, Shanghai (CN)

(73) Assignee: Alcatel Lucent, Boulogne Billancourt (FR)

(21) Appl. No.: 14/647,578

(22) PCT Filed: Nov. 6, 2013
(86) PCT No.: PCT/IB2013/002723

§ 371 Date: May 27, 2015

(30) Foreign Application Priority Data
Nov. 27, 2012 (CN) 201210491556.6

(51) Int. Cl. H04W 16/14; H04W 72/04; H04J 3/12

(52) U.S. Cl. CPC H04W 16/14; H04J 3/12; H04W 72/0453

(57) ABSTRACT

The invention provides a method of spectrum detection in a user equipment of a communication system, the method including: for each detection period, detecting a signal from a target system in a specific downlink detection sub-frame of each frame in a detection duration; and sending a detection result to a base station at the end of the detection duration. The specific downlink detection sub-frame is a sub-frame #4 or #9 in a downlink/uplink sub-frame configuration 1; a sub-frame #4 or #9 in a configuration 2; a sub-frame #7 in a configuration 3; a sub-frame #4 or #7 in a configuration 4; and a sub-frame #3, #4, #7 or #9 in a configuration 5 of a TDD system. The specific downlink detection sub-frame is any other downlink sub-frame than sub-frames #0 and #5 in an FDD system. There is further provided a method of spectrum detection in a base station of a communication system, the method including: receiving detection result(s) from one or more user equipments; and determining whether one or more frequency bands of a target system are available according to the detection result(s).

### FIELD OF THE INVENTION

The present disclosure relates to a communication system and particularly to the spectrum detection and the design of detection frame structure in a communication system.

### BACKGROUND OF THE INVENTION

The 3^{rd} generation partnership project (3GPP) Long Term Evolution (LTE) system has been considered as one of the most promising cellular networks in the future. In LTE-Advanced (LTE-A), technologies such as carrier aggregation, advanced MIMO, relay, etc., are further incorporated to enhance the performance of the system. Despite these valuable features, the scarce of spectrum resources still hinders the LTE-A system from realizing its full potential.

While on the other hand, there are underutilized spectrum resources remaining on those frequency bands with low or even no activities. For example, Ultra High Frequency (UHF) band TV white spaces (TVWSs), which have been released due to the transition of analog TV to digital TV, can be opportunistically accessed by the LTE-A system for further performance improvement. To take advantage of this opportunity, it is essential for the LTE-A system to be equipped with a Base Station (BS) and a User Equipment (UE) with an out-band spectrum detection ability, and it is necessary to design a detection frame structure for reliable out-band spectrum detection.

### SUMMARY OF THE INVENTION

In LTE-A, inter-frequency measurement has been defined for an inter-frequency handover or a handover between different Air Interface Technologies (an inter-RAT handover). In a corresponding frame structure, a 6 ms measurement gap has been defined at a repetition period of 40 ms or 80 ms as illustrated in FIG. 1. During the measurement gap, the user equipment tries to synchronize to a target cell base station and measure the reference signal on a different frequency carrier; and then sends a measurement report to a serving base station for a handover decision.

This measurement procedure of the user equipment requires the target system to be a cellular system and provided with a known synchronization signal and reference signal; and moreover the 6 ms measurement gap is selected because the target cellular system is supposed to contain the synchronization signal within this period. However it is neither necessary nor appropriate to apply the 6 ms measurement gap in a general case, for example, of TVWS spectrum detection.

In view of the above, it is necessary to provide a detection frame structure with a shorter measurement gap for spectrum detection so as to alleviate the influence on data transmission of the current frame.

The main idea of the invention is to reduce the detection period from the legacy 6 ms measurement gap to a 1 ms sub-frame level. Time resources can thus be saved for improving the HARQ performance or the spectrum efficiency of data transmission.

In an embodiment of an aspect, the invention provides a method of spectrum detection in a user equipment of a communication system, the method including the steps of: a. for each detection period, detecting a signal from a target system in a specific downlink detection sub-frame of each frame in a detection duration; and b. sending a detection result to a base station at the end of the detection duration, wherein the detection result is used for determining whether one or more frequency bands of the target system are available.

Advantageously the specific downlink detection sub-frame is a sub-frame #4 or a sub-frame #9 in a downlink/uplink sub-frame configuration 1 of a TDD system; the specific downlink detection sub-frame is a sub-frame #4 or a sub-frame #9 in a downlink/uplink sub-frame configuration 2 of the TDD system; the specific downlink detection sub-frame is a sub-frame #7 in a downlink/uplink sub-frame configuration 3 of the TDD system; the specific downlink detection sub-frame is a sub-frame #4 or a sub-frame #7 in a downlink/uplink sub-frame configuration 4 of the TDD system; and the specific downlink detection sub-frame is a sub-frame #3, a sub-frame #4, a sub-frame #7 or a sub-frame #9 in a downlink/uplink sub-frame configuration 5 of the TDD system.

Advantageously the specific downlink detection sub-frame is any other downlink sub-frame than a downlink sub-frame #0 and a downlink sub-frame #5 in a downlink sub-frame in an FDD system.

Advantageously the one or more frequency bands of the target system are an out-of-band frequency band(s).

Advantageously the length of the detection period Tₚ depends upon activity characteristic of the target system; and the length of the detection duration T_{d} depends upon the difficulty to detect the signal of the target system.

In an embodiment of another aspect, the invention provides a method of spectrum detection in a base station of a communication system, the method including the steps of: i. receiving a detection result(s) from one or more user equipments; and ii. determining whether one or more frequency bands of a target system are available according to the detection result(s) from the one or more user equipments.

Advantageously the method further includes the step of:—for each detection period, detecting a signal from the target system in a specific uplink detection sub-frame of each frame in a detection duration; wherein the step ii includes: determining whether the one or more frequency bands of the target system are available according to the detection result(s) from the one or more user equipments and a detection result of the base station.

Advantageously the specific uplink detection sub-frame is a sub-frame #8 when a specific downlink detection sub-frame is a sub-frame #4, and the specific uplink detection sub-frame is a sub-frame #3 when a specific downlink detection sub-frame is a sub-frame #9, in a downlink/uplink sub-frame configuration 1 of a TDD system.

Advantageously the specific uplink detection sub-frame is a specific uplink detection sub-frame, in an uplink frame, spaced from a specific downlink detection sub-frame by 4 ms in an FDD system.

In an embodiment of a further aspect, the invention provides an apparatus for spectrum detection in a user equipment of a communication system, the apparatus including: a first detecting unit configured to, for detection period, detect a signal from a target system in a specific downlink detection sub-frame of each frame in a detection duration; and a sending unit configured to send a detection result to a base station at the end of the detection duration, wherein the detection result is used for determining whether one or more frequency bands of the target system are available.

In an embodiment of a further aspect, the invention provides an apparatus for spectrum detection in a base station of a communication system, the apparatus including: a receiving unit configured to receive detection result(s) from one or more user equipments; and a determining unit configured to determine whether one or more frequency bands of a target system are available according to the detection result(s) from the one or more user equipments.

Advantageously the apparatus further includes: a second detecting unit configured to, for detection period, detect a signal from the target system in a specific uplink detection sub-frame of each frame in a detection duration; wherein the determining unit is further configured to determine whether the one or more frequency bands of the target system are available according to the detection result(s) from the one or more user equipments and a detection result of the base station.

The inventive solution is applicable to both in-band spectrum detection and out-band spectrum detection, for example, when the communication system is an LTE-A system, the target system can also be an LTE-A system, and at this time the foregoing one or more frequency bands are in-band frequency bands; and when the communication system is an LTE-A system, the target system can alternatively be a TV system, for example, and at this time the foregoing one or more frequency bands are out-band frequency bands.

In the inventive solutions, spectrum detection has an alleviated influence un data transmission of the current frame due to the use of a shorter detection gap (that is, the length of one sub-frame). With the inventive design solution of the detection frame structure, it is possible for the user equipment to perform spectrum detection and data transmission concurrently in a slot to thereby improve the performance (e.g., HARQ and spectrum efficiency) of the system.

The respective aspects of the invention will become more apparent from the following description of particular embodiments.

### BRIEF DESCRIPTION OF DRAWINGS

The foregoing and other features of the invention will become more apparent upon review of the following detailed description of non-limiting embodiments taken with reference to the drawings in which:

FIG. 1 illustrates a schematic diagram of the measurement procedure of the user equipment in an RRC_Connected status in the prior art;

FIG. 2 illustrates a schematic diagram of a detection frame structure design of an FDD system according to an embodiment of the invention;

FIG. 3 illustrates a schematic diagram of a detection frame structure design of a downlink/uplink sub-frame configuration 1 of a TDD system according to an embodiment of the invention;

FIG. 4 illustrates a schematic diagram of a detection frame structure design of a downlink/uplink sub-frame configuration 2 of the TDD system according to an embodiment of the invention;

FIG. 5 illustrates a schematic diagram of a detection frame structure design of a downlink/uplink sub-frame configuration 3 of the TDD system according to an embodiment of the invention;

FIG. 6 illustrates a schematic diagram of a detection frame structure design of a downlink/uplink sub-frame configuration 4 of the TDD system according to an embodiment of the invention; and

FIG. 7 illustrates a schematic diagram of a detection frame structure design of a downlink/uplink sub-frame configuration 5 of the TDD system according to an embodiment of the invention.

Identical or similar reference numerals denote identical or similar components throughout the drawings.

### DETAILED DESCRIPTION OF EMBODIMENTS

The key point of the detection frame structure of the invention is to select an appropriate detection sub-frame without influencing HARQ timing as well as broadcast and synchronization channels of the LTE-A system.

For an FDD system, the downlink sub-frame #0 and #5 can not be used for downlink detection as they carry important system information and synchronization signals. Except for these two downlink sub-frames, any other downlink sub-frame in the downlink frame can be used for downlink detection, and correspondingly an uplink sub-frame, in the uplink frame, spaced from the downlink sub-frame by 4 ms can be used for uplink detection. For example, when the downlink sub-frame #1 in the downlink frame is used for downlink detection, then the uplink sub-frame #5 in the uplink frame is used for uplink detection. The fixed 4 ms delay of HARQ timing makes it flexible to select the downlink and uplink detection sub-frames of the FDD system to thereby minimize the influence of the selection of the detection sub-frames on the HARQ procedure.

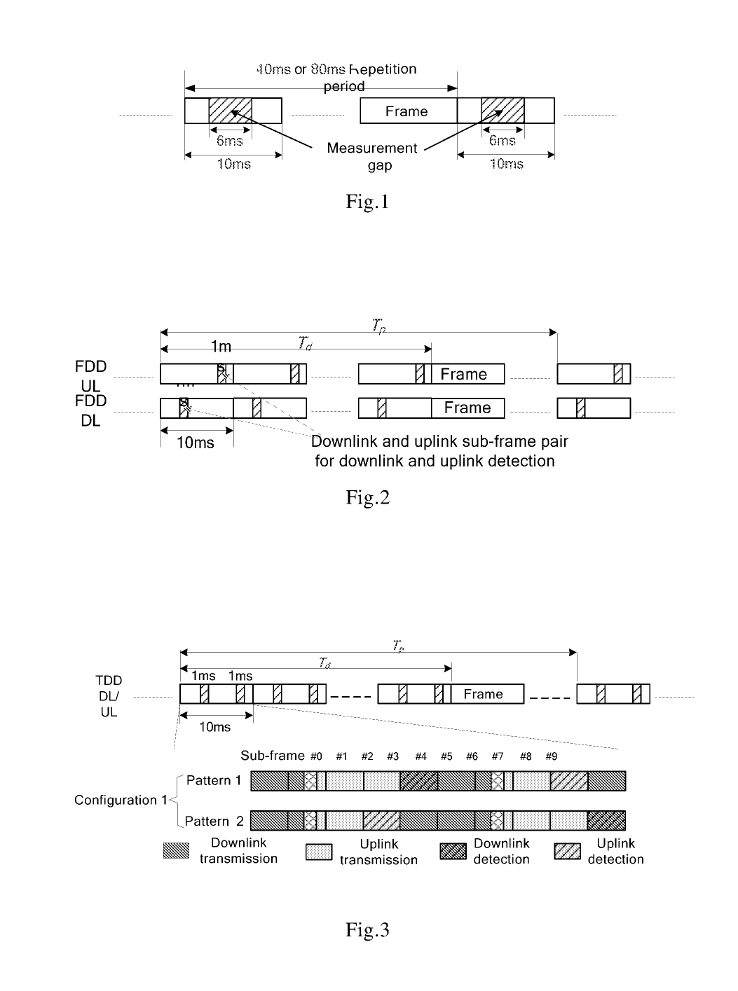

For the FDD system, the detection frame structure thereof is as illustrated in FIG. 2, where T_{d} represents the detection duration (where each frame in the detection duration includes a detection sub-frame), and Tₚ represent the detection period. Particularly the length of the detection duration T_{d} depends upon the difficulty to detect the signal of a target system; and the length of the detection period Tₚ depends upon the activity characteristic of a target system.

For a TDD system, the selection of a downlink detection sub-frame and an uplink detection sub-frame is more complex than the FDD system due to different DL/UL sub-frame configurations. The DL/UL sub-frame configurations of the TDD system are as depicted in Table 1 below:

TABLE 1
DL/UL sub-frame configurations of TDD system

| DL/UL | Sub-frame No. | | | | | | | | | |
|---|---|---|---|---|---|---|---|---|---|---|
| Configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

Where “D” represents the downlink sub-frame, “U” represents the uplink sub-frame, and “S” represents the special sub-frame including a DwPTS, a GP and an UpPTS. The TDD sub-frames #0, #1, #5 and #6 carry important system information and synchronization signals, so they cannot be used for spectrum detection. Moreover the detection sub-frames shall be selected without violating HARQ timing constraints for the different DL/UL sub-frame configurations.

Designs of detection frame structures for the respective DL/UL sub-frame configurations of the TDD system will be described below respectively.

Configuration 1

For the configuration 1, the detection frame structure is as illustrated in FIG. 3, where T_{d} represents the detection duration (where each frame in the detection duration includes a detection sub-frame), and Tₚ represent the detection period. Particularly the length of the detection duration T_{d} depends upon the difficulty to detect the signal of a target system; and the length of the detection period Tₚ depends upon the activity characteristic of a target system.

There are illustrated two design patterns. In the pattern 1, the downlink sub-frame #4 is selected for downlink detection, and the uplink sub-frame #8 is selected for uplink detection; and in the pattern 2, the downlink sub-frame #9 is selected for downlink detection, and the uplink sub-frame #3 is selected for uplink detection. The downlink sub-frame #4 and the uplink sub-frame #8 are selected as a pair of uplink-downlink sub-frames or the uplink sub-frame #3 and the downlink sub-frame #9 are selected as a pair of uplink-downlink sub-frames for spectrum detection due to the following reasons:

According to 3GPP TS 36.213:
1) Uplink grant and uplink data transmission occurs in 1→7, 4→8, 6→2, 9→3, for example, uplink grant is transmitted in the sub-frame #6, and then uplink data is transmitted in the sub-frame #2 of the next frame;

2) Uplink data transmission and the downlink ACK/NACK occurs in 7→1, 8→4, 2→6, 3→9, for example, uplink data is transmitted in the sub-frame #2, and then the downlink ACK/NACK is transmitted in the sub-frame #6; and
3) Downlink data transmission and the uplink ACK/NACK occurs in 5→2, 6→2, 9→3, 0→7, 1→7, 7→8, for example, downlink data is transmitted in the sub-frame #5, and then the uplink ACK/NACK is transmitted in the sub-frame #2 of the next frame.

Since the sub-frames #0, #1, #5 and #6 carry important system information and synchronization signals, they can not be used for spectrum detection, and in order to maintain the foregoing timing, the sub-frames #2 and #7 can not be used for spectrum detection either due to the timing of 1→7, 6→2, 5→2, 0→7. Therefore, for the configuration 1, only the pair of uplink-downlink sub-frames #4←→#8 or #3←→#9 can be used as detection sub-frames.

With this frame detection structure design, except for the pair of uplink-downlink sub-frames #4←→#8 or #3←→#9, HARQ procedure on the other sub-frames will not be influenced.

The method of spectrum detection according to the invention will be described below taking the selected pair of uplink-downlink sub-frames #4←→#8 as an example.

At the user equipment side, first the user equipment detects, for each detection period Tₚ, the signal from a target system in the downlink detection sub-frame #4 of each frame in the detection duration T_{d}. Then the user equipment sends the detection result to the base station at the end of the detection duration, wherein the detection result is used for determining whether one or more frequency bands of the target system are available.

Advantageously a plurality of user equipments can perform joint detection and send detection results to the base station for improved reliability of detection.

At the base station side, first the base station detects, for each detection period Tₚ, the signal from the target system in the uplink detection sub-frame #8 of each frame in the detection duration T_{d}; and then the base station determines whether the one or more frequency bands of the target system are available according to the detection result(s) from the one or more user equipments and the detection result of the base station itself.

Configuration 2

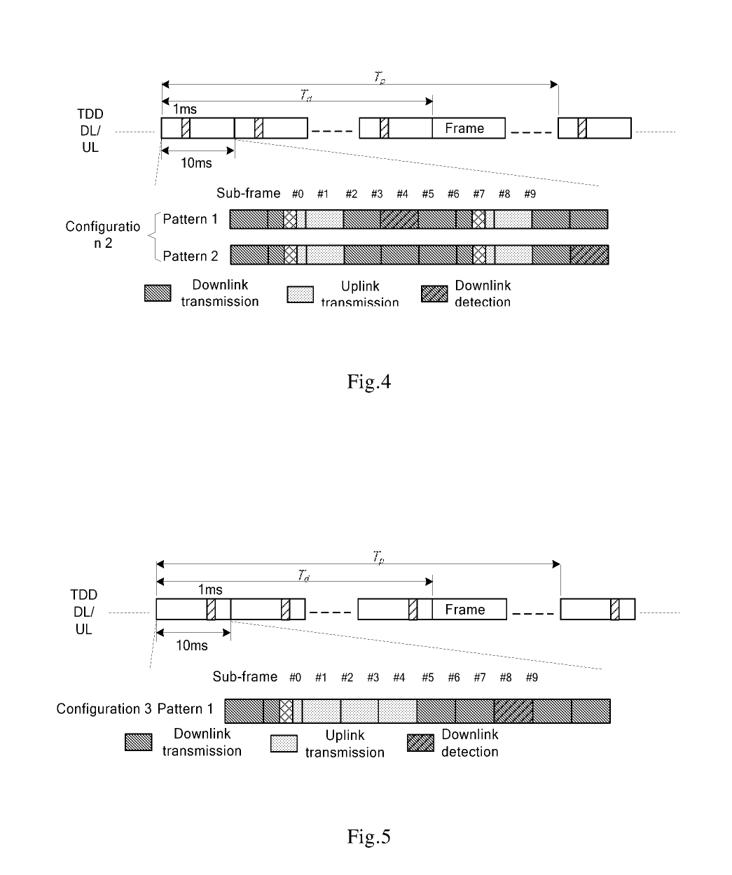

For the configuration 2, the detection frame structure is as illustrated in FIG. 4, where T_{d} represents the detection duration, and Tₚ represents the detection period.

There are illustrated two design patterns. In the pattern 1, the downlink sub-frame #4 is selected for downlink detection; and in the pattern 2, the downlink sub-frame #9 is selected for downlink detection. The downlink sub-frame #4 is selected as the downlink detection sub-frame or the downlink sub-frame #9 is selected as the downlink detection sub-frame for spectrum detection due to the following reasons:

According to 3GPP TS 36.213:

1) Uplink grant and uplink data transmission occurs in 3→7, 8→2;

2) Uplink data transmission and the downlink ACK/NACK occurs in 7→3, 2→8; and
3) Downlink data transmission and the uplink ACK/NACK occurs in 4→2, 5→2, 8→2, 6→2, 9→7, 0→7, 3→7, 1→7.

Since the sub-frames #0, #1, #5 and #6 carry important system information and synchronization signals, they can not be used for spectrum detection, and in order to maintain the foregoing timing, the sub-frames #2 and #7 can not be used for uplink detection either due to the timing of 5→2, 6→2, 0→7, 1→7. Therefore, for the configuration 2, there is no uplink detection sub-frame available. Furthermore the sub-frames #8 and #3 can not be used for downlink detection either due to the timing of 2→8, 7→3. Thus only the downlink sub-frame #4 or #9 can be used for downlink detection.

With this frame detection structure design, the downlink sub-frame #4 or #9 can not be used for the downlink HARQ procedure. However no uplink HARQ procedure will be influenced due to the absence of the uplink HARQ procedure related to the downlink sub-frame #4 or #9.

The method of spectrum detection according to the invention will be described below taking the selected downlink sub-frame #4 as an example.

At the user equipment side, first the user equipment detects, for each detection period Tₚ, the signal from a target system in the downlink detection sub-frame #4 of each frame in the detection duration T_{d}. Then the user equipment sends the detection result to the base station at the end of the detection duration, wherein the detection result is used for determining whether one or more frequency bands of the target system are available.

Advantageously a plurality of user equipments can perform joint detection and send detection results to the base station for improved reliability of detection.

At the base station side, the base determines whether the one or more frequency bands of the target system are available according to the detection result(s) from the one or more user equipments.

Configuration 3

For the configuration 3, the detection frame structure is as illustrated in FIG. 5, where T_{d} represents the detection duration, and Tₚ represents the detection period.

There is illustrated a design pattern. In the pattern, the downlink sub-frame #7 is selected for downlink detection. The downlink sub-frame #7 is selected as the downlink detection sub-frame for spectrum detection due to the following reasons:

According to 3GPP TS 36.213:

1) Uplink grant and uplink data transmission occurs in 0→→, 8→2, 9→3;

2) Uplink data transmission and the downlink ACK/NACK occurs in 4→0, 2→8, 3→9; and

3) Downlink data transmission and the uplink ACK/NACK occurs in 5→2, 6→2, 1 (the sub-frame #1 of the previous frame)→2, 7→3, 8→3, 9→4, 0→4.

Since the sub-frames #0, #1, #5 and #6 carry important system information and synchronization signals, they can not be used for spectrum detection, and in order to maintain the foregoing timing, the sub-frames #2 and #4 can not be used for uplink detection either due to the timing of 0→4, 5→2, 6→2, 1 (the sub-frame #1 of the previous frame)→2. Furthermore the sub-frames #8, #3 and #9 can not be used for spectrum detection either due to the timing of 2→8, 8→3, 3→9. Thus only the downlink sub-frame #7 can be used for downlink detection.

With this frame detection structure design, the downlink sub-frame #7 can not be used for the downlink HARK procedure. However no uplink HARQ procedure will be influenced due to the absence of an uplink HARQ procedure related to the downlink sub-frame #7.

For the configuration 3, the method of spectrum detection according to the invention is similar to the method of spectrum detection in the configuration 2, and a repeated description thereof will be omitted here for the sake of conciseness.

Configuration 4

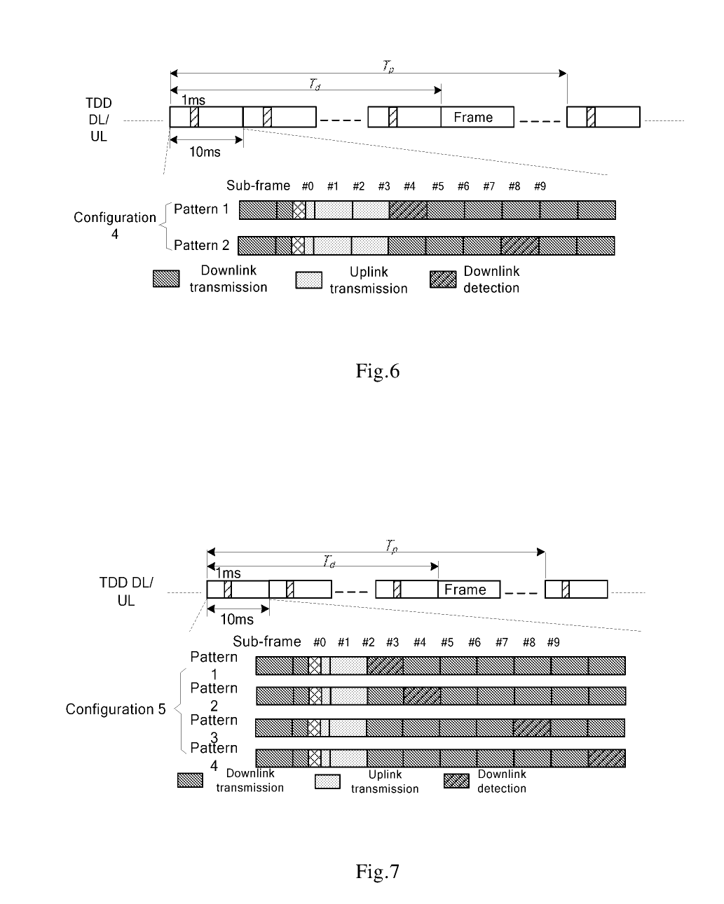

For the configuration 4, the detection frame structure is as illustrated in FIG. 6, where T_{d} represents the detection duration, and Tₚ represents the detection period.

There are illustrated two design patterns. In the pattern 1, the downlink sub-frame #4 is selected for downlink detection; and in the pattern 2, the downlink sub-frame #7 is selected for downlink detection. The downlink sub-frame #4 is selected as the downlink detection sub-frame or the downlink sub-frame #7 is selected as the downlink detection sub-frame for spectrum detection due to the following reasons:

According to 3GPP TS 36.213:

1) Uplink grant and uplink data transmission occurs in 8→2, 9→3;

2) Uplink data transmission and the downlink ACK/NACK occurs in 2→8, 3→9; and

3) Downlink data transmission and the uplink ACK/NACK occurs in 0 (the sub-frame #0 of the previous frame)→2, 4→2, 5→2, 1(the sub-frame #1 of the previous frame)→2, 7→3, 8→3, 9→3, 6→3.

Since the sub-frames #0, #1, #5 and #6 carry important system information and synchronization signals, they can not be used for spectrum detection, and in order to maintain the foregoing timing, the sub-frames #2 and #3 can not be used for uplink detection either due to the timing of 0 (the sub-frame #0 of the previous frame)→2, 5→2, 1(the sub-frame #1 of the previous frame)→2, 6→3. Furthermore the sub-frames #8 and #9 can not be used for downlink detection either due to the timing of 2→8, 3→9. Thus only the downlink sub-frame #4 or #7 can be used for downlink detection.

With this frame detection structure design, the downlink sub-frame #4 or #7 can not be used for the downlink HARQ procedure. However no uplink HARQ procedure will be influenced due to the absence of an uplink HARQ procedure related to the downlink sub-frame #4 or #7.

For the configuration 4, the method of spectrum detection according to the invention is similar to the method of spectrum detection in the configuration 2, and a repeated description thereof will be omitted here for the sake of conciseness.

Configuration 5

For the configuration 4, the detection frame structure is as illustrated in FIG. 7, where T_{d} represents the detection duration, and Tₚ represents the detection period.

There are illustrated fourth design patterns. In the pattern 1, the downlink sub-frame #3 is selected for downlink detection; in the pattern 2, the downlink sub-frame #4 is selected for downlink detection; in the pattern 3, the downlink sub-frame #7 is selected for downlink detection; and in the pattern 4, the downlink sub-frame #9 is selected for downlink detection. The downlink sub-frame #3, #4, #7 or #9 is selected as the downlink detection sub-frame for spectrum detection due to the following reasons:

According to 3GPP TS 36.213:

1) Uplink grant and uplink data transmission occurs in 8→2;

2) Uplink data transmission and the downlink ACK/NACK occurs in 2→8; and
3) Downlink data transmission and the uplink ACK/NACK occurs in 8→2, 7→2, 6→2, 5→2, 4→2, 3→2, 1 (the sub-frame #1 of the previous frame)→2, 0 (the sub-frame #0 of the previous frame)→2, 9 (the sub-frame #9 of the previous frame)→2.

Since the sub-frames #0, #1, #5 and #6 carry important system information and synchronization signals, they can not be used for spectrum detection, and in order to maintain the foregoing timing, the sub-frame #2 can not be used for uplink detection either due to the timing of 6→2, 5→2, 1 (the sub-frame #1 of the previous frame)→2, 0 (the sub-frame #0 of the previous frame)→2. Furthermore the sub-frame #8 can not be used for downlink detection either due to the timing of 248.

Thus only the downlink sub-frame #3, #4, #7 or #9 can be used for downlink detection.

With this frame detection structure design, the downlink sub-frame #3, #4, #7 or #9 can not be used for the downlink HARQ procedure. However no uplink HARQ procedure will be influenced due to the absence of an uplink HARQ procedure related to the downlink sub-frame #3, #4, #7 or #9.

For the configuration 5, the method of spectrum detection according to the invention is similar to the method of spectrum detection in the configuration 2, and a repeated description thereof will be omitted here for the sake of conciseness.

For the configuration 6 and the configuration 0, there is no sub-frame available for spectrum detection. They will be described below respectively.

Configuration 6

According to 3GPP TS 36.213:

1) Uplink grant and uplink data transmission occurs in 0→7, 1→8, 5→2, 6→3, 9→4;

2) Uplink data transmission and the downlink ACK/NACK occurs in 4→0, 7→1, 8→5, 2→6, 3→9; and
3) Downlink data transmission and the uplink ACK/NACK occurs in 5→2, 6→3, 9→4, 0→7, 1→8.

Since the sub-frames #0, #1, #5 and #6 carry important system information and synchronization signals, they can not be used for spectrum detection, and in order to maintain the foregoing timing, the sub-frames #2, #3, #7 and #8 can not be used for uplink detection either due to the timing of 5→2, 6→3, 0→7, 1→8. Furthermore the sub-frames #9 and #4 can not be used for spectrum detection either due to the timing of 9→4. Thus, there is no sub-frame available to spectrum detection in the configuration 6 if HARQ timing is strictly followed.

Configuration 0

According to 3GPP TS 36.213:
1) Uplink grant and uplink data transmission occurs in 0→4, 1→7, 5→9, 6→2;

2) Uplink data transmission and the downlink ACK/NACK occurs in 3→0, 7→1, 8→5, 2→6; and
3) Downlink data transmission and the uplink ACK/NACK occurs in 6→2, 0→4, 1→7, 5→9.

Since the sub-frames #0, #1, #5 and #6 carry important system information and synchronization signals, they can not be used for spectrum detection, and in order to maintain the foregoing timing, the sub-frames #4, #7, #9 and #2 can not be used for uplink detection either due to the timing of 0→4, 1→7, 5→9, 6→2. Furthermore if the uplink sub-frame #3 or #8 is used for spectrum detection, then uplink HARQ procedures in the remaining sub-frames #2, #4, #7 and #9 will be influenced. Thus the sub-frame #3 or #8 can not be used for uplink detection either. Thus, there is no sub-frame available to spectrum detection in the configuration 0.

Those skilled in the art shall appreciate that the invention apparently will not be limited to the foregoing exemplary embodiments and can be embodied in other specific forms without departing from the spirit or essence of the invention. Accordingly the embodiments shall be construed anyway to be exemplary and non-limiting, and any reference numerals in the claims shall not be construed as limiting the claims in question. Moreover apparently the term “comprising” will not preclude another element(s) or step(s), and the term “a” or “an” preceding an element will not preclude a plurality of such elements. A plurality of elements stated in an apparatus claim can alternatively be embodied as a single element in software or hardware. The terms “first”, “second”, etc., are intended to designate a name but not to suggest any specific order.

1. A method of spectrum detection in a user equipment of a communication system, the method comprising:
for each detection period, detecting a signal from a target system in a specific downlink detection sub-frame of each frame in a detection duration; and
sending a detection result to a base station at the end of the detection duration, wherein the detection result is used for determining whether one or more frequency bands of the target system are available.

2. The method according to claim 1, wherein the specific downlink detection sub-frame is:
a sub-frame #4 or a sub-frame #9 in a downlink/uplink sub-frame configuration 1 of a TDD system;
a sub-frame #4 or a sub-frame #9 in a downlink/uplink sub-frame configuration 2 of the TDD system;
a sub-frame #7 in a downlink/uplink sub-frame configuration 3 of the TDD system;
a sub-frame #4 or a sub-frame #7 in a downlink/uplink sub-frame configuration 4 of the TDD system; and
a sub-frame #3, a sub-frame #4, a sub-frame #7 or a sub-frame #9 in a downlink/uplink sub-frame configuration 5 of the TDD system.

3. The method according to claim 1, wherein the specific downlink detection sub-frame is any other downlink sub-frame than a downlink sub-frame #0 and a downlink sub-frame #5 in a downlink sub-frame in an FDD system.

4. The method according to claim 1, wherein the one or more frequency bands of the target system are an out-of-band frequency band(s).

5. The method according to claim 1, wherein the length of the detection period Tₚ depends upon activity characteristic of the target system.

6. The method according to claim 1, wherein the length of the detection duration T_{d} depends upon the difficulty to detect the signal of the target system.

7. A method of spectrum detection in a base station of a communication system, the method comprising:
receiving a detection result(s) from one or more user equipments; and
determining whether one or more frequency bands of a target system are available according to the detection result(s) from the one or more user equipments.

8. The method according to claim 7, wherein the method further comprises:
for each detection period, detecting a signal from the target system in a specific uplink detection sub-frame of each frame in a detection duration;
wherein the determining comprises: determining whether the one or more frequency bands of the target system are available according to the detection result(s) from the one or more user equipments and a detection result of the base station.

9. The method according to claim 8, wherein the specific uplink detection sub-frame is a sub-frame #8 when a specific downlink detection sub-frame is a sub-frame #4, and the specific uplink detection sub-frame is a sub-frame #3 when a specific downlink detection sub-frame is a sub-frame #9, in a downlink/uplink sub-frame configuration 1 of a TDD system.

10. The method according to claim 8, wherein the specific uplink detection sub-frame is a specific uplink detection sub-frame, in an uplink frame, spaced from a specific downlink detection sub-frame by 4 ms in an FDD system.

11. An apparatus for spectrum detection in a user equipment of a communication system, the apparatus comprising:
a first detecting unit configured to, for detection period, detect a signal from a target system in a specific downlink detection sub-frame of each frame in a detection duration; and
a sending unit configured to send a detection result to a base station at the end of the detection duration, wherein the detection result is used for determining whether one or more frequency bands of the target system are available.

12. The apparatus according to claim 11, wherein the specific downlink detection sub-frame is:
a sub-frame #4 or a sub-frame #9 in a downlink/uplink sub-frame configuration 1 of a TDD system;
a sub-frame #4 or a sub-frame #9 in a downlink/uplink sub-frame configuration 2 of the TDD system;
a sub-frame #7 in a downlink/uplink sub-frame configuration 3 of the TDD system;
a sub-frame #4 or a sub-frame #7 in a downlink/uplink sub-frame configuration 4 of the TDD system;
a sub-frame #3, a sub-frame #4, a sub-frame #7 or a sub-frame #9 in a downlink/uplink sub-frame configuration 5 of the TDD system; and
any other downlink sub-frame than a downlink sub-frame #0 and a downlink sub-frame #5 in a downlink sub-frame in an FDD system.

13. An apparatus for spectrum detection in a base station of a communication system, the apparatus comprising:
a receiving unit configured to receive detection result(s) from one or more user equipments; and
a determining unit configured to determine whether one or more frequency bands of a target system are available according to the detection result(s) from the one or more user equipments.

14. The apparatus according to claim 13, wherein the apparatus further comprises:
a second detecting unit configured to, for detection period, detect a signal from the target system in a specific uplink detection sub-frame of each frame in a detection duration;
wherein the determining unit is further configured to determine whether the one or more frequency bands of the target system are available according to the detection result(s) from the one or more user equipments and a detection result of the base station.

15. The apparatus according to claim 14, wherein the specific uplink detection sub-frame is a sub-frame #8 when a specific downlink detection sub-frame is a sub-frame #4, and the specific uplink detection sub-frame is a sub-frame #3 when a specific downlink detection sub-frame is a sub-frame #9, in a downlink/uplink sub-frame configuration 1 of a TDD system; and the specific uplink detection sub-frame is a specific uplink detection sub-frame, in an uplink frame, spaced from a specific downlink detection sub-frame by 4 ms in an FDD system.
